(19) United States
(12) Patent Application Publication
(10) Pub. No.: US 2025/0070147 A1
(43) Pub. Date: Feb. 27, 2025

(54) NEGATIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Jungmin LEE, Yongin-si (KR); Minjae KIM, Yongin-si (KR); Won-Gi AHN, Yongin-si (KR); Kukjoo LEE, Yongin-si (KR)

(21) Appl. No.: 18/942,087

(22) Filed: Nov. 8, 2024

Related U.S. Application Data
(63) Continuation-in-part of application No. 17/961,475, filed on Oct. 6, 2022.

(30) Foreign Application Priority Data
Oct. 7, 2021 (KR) 10-2021-0133341

(51) Int. Cl. H01M 4/38; H01M 4/02; H01M 4/04; H01M 4/583; H01M 4/62; H01M 10/0525

(52) U.S. Cl. CPC H01M 4/386; H01M 4/0404; H01M 4/583; H01M 4/622; H01M 10/0525; H01M 2004/027; H01M 2220/30

(57) ABSTRACT

Disclosed herein is a negative electrode including a current collector, a first active material layer on the current collector, and a second active material layer on the first active material layer, wherein the first active material layer and the second active material layer each independently includes a silicon-based active material and a binder, and the binder includes a copolymer (A) and a copolymer (B), the copolymer (A) includes a unit (a−1) derived from a (meth)acrylic acid-based monomer and a unit (a−2) derived from a (meth)acrylonitrile monomer, and the copolymer (B) includes a unit (b−1) derived from an aromatic vinyl-based monomer and a unit (b−2) derived from an ethylenically unsaturated monomer that is at least one of an unsaturated carboxylic acid alkyl ester monomer, a (meth)acrylic acid-based monomer, an unsaturated carboxylic acid amide monomer, or a conjugated diene monomer, and a rechargeable lithium battery including the same.

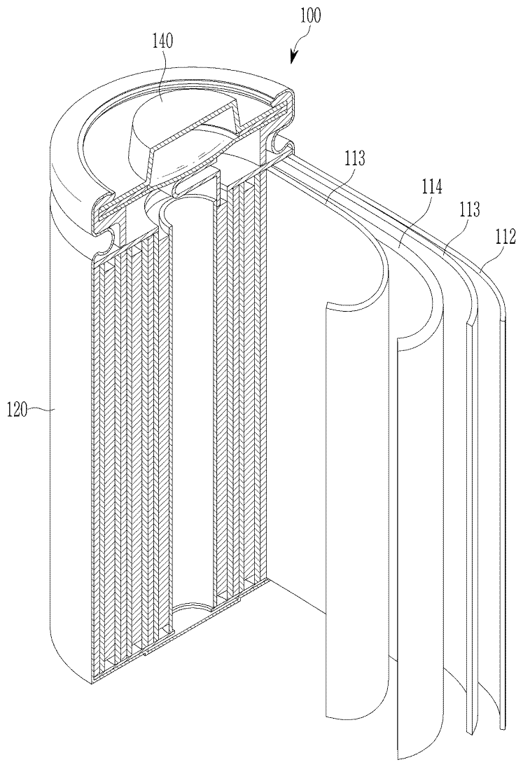

### CROSS-REFERENCE TO RELATED APPLICATION

This application is a Continuation-in-Part of U.S. application Ser. No. 17/961,475, filed Oct. 6, 2022, which claims priority to and the benefit of Korean Patent Application No. 10-2021-0133341, filed in the Korean Intellectual Property Office on Oct. 7, 2021, the entire content of each of which is herein incorporated by reference.

### BACKGROUND

### 1. Field

One or more embodiments of the present disclosure relate to a negative electrode for a rechargeable lithium battery and a rechargeable lithium battery including the same.

### 2. Description of the Related Art

Portable information devices (such as cell phones, laptops, smart phones, and/or the like) and/or electric vehicles have used rechargeable lithium batteries having high energy densities and easy portability as driving power sources. Recently, research has been actively conducted to use rechargeable lithium batteries with large capacity and high energy density as driving power sources or power storage power sources for hybrid or electric vehicles.

As an example of a method for increasing the capacity of rechargeable lithium batteries, a silicon-containing active material for a negative electrode may be utilized. When an active material contains silicon atoms having a higher amount of lithium intercalation/deintercalation than a related art carbon-based active material is applied to the negative electrode, battery capacity may be improved. However, because the silicon-based active material has a large volume change accompanying the lithium intercalation and deintercalation, a negative active material layer may violently expand and contract during the charge and discharge. As a result, electron conductivity between negative active materials is lowered, and the negative active material with a current collector may be blocked from electron movement, deteriorating cycle characteristics of the rechargeable battery.

In order to solve this problem, research on changing the structure or composition of the silicon-based negative active material is in progress, and research on a negative electrode binder has been conducted. However, there have been limitations in practically applying the silicon-based negative active material, leading to a lack of improvement in battery cycle characteristics, insufficiently suppressing electrode expansion, and/or the like.

### SUMMARY

Aspects of one or more embodiments of the present disclosure provide a negative electrode with a multilayer structure, which is effectively suppressed or reduced from expansion by the silicon-based negative active material, realizes high capacity, and improves cycle characteristics, and a rechargeable lithium battery including the same.

Additional aspects will be set forth in part in the description which follows and, in part, will be apparent from the description, or may be learned by practice of the presented embodiments of the disclosure.

In one or more embodiments of the present disclosure, a negative electrode for a rechargeable lithium battery includes a current collector, a first active material layer on the current collector, and a second active material layer on the first active material layer, wherein the first active material layer and the second active material layer each independently comprises a silicon-based active material and a binder, and the binder includes a copolymer (A) and a copolymer (B), and the copolymer (A) includes a unit (a−1) derived from a (meth)acrylic acid-based monomer and a unit (a−2) derived from a (meth)acrylonitrile monomer, and the copolymer (B) includes a unit (b−1) derived from an aromatic vinyl-based monomer and a unit (b−2) derived from an ethylenically unsaturated monomer that is at least one of an unsaturated carboxylic acid alkyl ester monomer, a (meth)acrylic acid-based monomer, an unsaturated carboxylic acid amide monomer, or a conjugated diene monomer.

In one or more embodiments of the present disclosure, a rechargeable lithium battery includes the negative electrode, a positive electrode, and an electrolyte.

A negative electrode for a rechargeable lithium battery according to one or more embodiments and a rechargeable lithium battery including the same have relatively very high capacity and excellent or suitable battery cycle characteristics while effectively suppressing or reducing electrode expansion due to a silicon-based negative active material.

### BRIEF DESCRIPTION OF THE DRAWING

The drawing is a schematic view illustrating a rechargeable lithium battery according to one or more embodiments of the present disclosure.

### DETAILED DESCRIPTION

Hereinafter, specific embodiments will be described in more detail so that those of ordinary skill in the art can easily implement them. However, this disclosure may be embodied in many different forms and is not construed as limited to the example embodiments set forth herein. Rather, these embodiments are provided as examples so that this disclosure will be thorough and complete, and will fully convey the aspects and features of the present disclosure to those skilled in the art.

Accordingly, processes, elements, and techniques that are not necessary to those having ordinary skill in the art for a complete understanding of the aspects and features of the present disclosure may not be described.

The terminology used herein is used to describe embodiments only, and is not intended to limit the present disclosure. As used herein, the singular forms “a” and “an” are intended to include the plural forms as well, unless the context clearly indicates otherwise.

As used herein, “combination thereof” means a mixture, laminate, composite, copolymer, alloy, blend, reaction product, and/or the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout, and duplicative descriptions thereof may not be provided the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, it will also be understood that when an element or layer is referred to as being “between” two elements or layers, it can be the only element or layer between the two elements or layers, or one or more intervening elements or layers may also be present.

In some embodiments, “layer” herein includes not only a shape formed on the whole surface when viewed from a plan view, but also a shape formed on a partial surface.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

In one or more embodiments, provided is a negative electrode for a rechargeable lithium battery including a current collector, a first active material layer on the current collector, and a second active material layer on the first active material layer. Herein, the first active material layer and the second active material layer include a silicon-based active material and a binder, and the binder includes a copolymer (A) and a copolymer (B). The binder including the copolymer (A) and the copolymer (B) is included in both the first active material layer and the second active material layer.

The copolymer (A) is a copolymer including a unit (a−1) derived from a (meth)acrylic acid-based monomer and a unit (a−2) derived from a (meth)acrylonitrile monomer. The copolymer (B) is a copolymer including a unit (b−1) derived from an aromatic vinyl-based monomer; and a unit (b−2) derived from an ethylenically unsaturated monomer that is at least one of an unsaturated carboxylic acid alkyl ester monomer, a (meth)acrylic acid-based monomer, an unsaturated carboxylic acid amide monomer, and a conjugated diene monomer.

The negative electrode for a rechargeable lithium battery is a type or kind of multi-layer negative electrode having two or more active material layers, and may implement high capacity and high energy density.

The first active material layer and the second active material layer include a silicon-based active material. The silicon-based active material refers to an active material containing silicon (e.g., a negative electrode active material containing silicon).

The silicon-based active material has a large volume change due to charging and discharging, and the negative active material layer including the same expands and contracts violently. Accordingly, problems such as a decrease in electron conductivity between the negative active materials and blocking of electron movement between the negative active material layer and the current collector may frequently occur. However, the negative electrode according to one or more embodiments of the present disclosure can solve this problem by utilizing a specific binder in the negative active material layer including the silicon-based active material, and at the same time improve basic battery characteristics such as high temperature cycle-life characteristics of the battery.

### Binder

Because the binder according to one or more embodiments includes the copolymer (A) and the copolymer (B), expansion of the electrode of the silicon-based negative electrode even with a small content (e.g., amount) may be suppressed or reduced and cycle characteristics may be improved at the same time.

The copolymer (A) and the copolymer (B) may be physically mixed, or the copolymer (A) and the copolymer (B) may be chemically bonded to exist in the form of dispersed particles.

The binder may be, for example, in a form in which the copolymer (A) and the copolymer (B) are individually mixed with each other. For example, the binder may be in a state in which the copolymer (A) and the copolymer (B) are physically mixed rather than having a core-shell structure. In this case, the binder may exhibit both (e.g., simultaneously) the characteristics of the copolymer (A) and the copolymer (B), and may effectively suppress or reduce electrode expansion while exhibiting excellent or suitable binding force.

As another example, the binder may be one in which the copolymer (A) and the copolymer (B) are chemically bonded, and at least a portion of the copolymer (B) is around (e.g., is surrounded by) the copolymer (A). The copolymer (B) may be prepared by copolymerizing in water in the presence of a polymer dispersion stabilizer consisting of the copolymer (A), and thus the water-insoluble copolymer (B) may aggregate into the inside of the binder particles. At least a portion or all of the copolymer (B) may be around (e.g., may be surrounded by) the water-soluble copolymer (A). As an example, the binder may be in the form of a core-shell having the copolymer (B) as a core and the copolymer (A) as a shell. In this case, a close contacting property between components included in the electrode may be improved, and electrode expansion may be efficiently controlled or reduced.

The binder may have, for example, a particle shape, and may have for example, a shape such as a spherical shape or an oval shape. Herein, the term “spherical” is understood as a concept including a substantially spherical shape as well as a perfect spherical shape, that is, a shape similar to a spherical shape or a rectangular oval shape.

The binder may include about 30 wt % to about 70 wt % of the copolymer (A) and about 70 wt % to about 30 wt % of the copolymer (B) based on 100 wt % of the binder. In one or more embodiments, in the binder, a weight ratio of copolymer (A):copolymer (B) may be about 30:70 to about 70:30. When the copolymer (A) and the copolymer (B) are included in the above range, strength, elastic modulus and flexibility of the binder may be improved, electrode expansion may be effectively suppressed or reduced, cracks in the negative active material layer may be suppressed or reduced, and cycle characteristics of the rechargeable lithium battery may be improved.

The copolymer (A) may include about 30 wt % to about 70 wt % of the unit (a-1) derived from the (meth)acrylic acid-based monomer and about 30 wt % to about 70 wt % of the unit (a−2) derived from (meth)acrylonitrile based on 100 wt % of the copolymer (A). For example, the copolymer (A) may include about 35 wt % to about 65 wt % of the unit (a−1) derived from the (meth)acrylic acid-based monomer and about 35 wt % to about 65 wt % of the unit (a−2) derived from (meth)acrylonitrile. When the content (e.g., amount) of the unit (a−1) derived from the (meth)acrylic acid-based monomer in the copolymer (A) is less than about 30 wt %, the copolymer (A) may have water-insoluble characteristics, which is not desirable, dispersibility of the negative active material may be reduced, and storage stability of the negative electrode slurry may be deteriorated. When the content (e.g., amount) of the unit (a−1) derived from the (meth)acrylic acid-based monomer in the copolymer (A) exceeds about 70 wt %, cracks occur in the electrode during application and drying of the negative electrode slurry, and thus it may not be easy to manufacture the negative electrode.

In one or more embodiments, when the content (e.g., amount) of the unit (a-2) derived from (meth)acrylonitrile in the copolymer (A) is less than about 30 wt %, close contacting properties of the negative electrode mixture layer to the substrate may be reduced. When the content (e.g., amount) of the unit (a−2) derived from the (meth)acrylonitrile in the copolymer (A) exceeds about 70 wt %, the copolymer (A) may have water-insoluble characteristics, which is not desirable, dispersibility of the negative active material may be reduced, and storage stability of the negative electrode slurry may be deteriorated.

The (meth)acrylic acid-based monomer may include, for example, at least one of (meth)acrylic acid, an alkali metal salt of (meth)acrylic acid, and/or an ammonium salt of (meth)acrylic acid. Herein, (meth)acrylic acid refers to acrylic acid or methacrylic acid. Examples of the alkali metal salt of (meth)acrylic acid may include sodium acrylate, lithium acrylate, potassium acrylate, calcium acrylate, magnesium acrylate, sodium methacrylate, lithium methacrylate, potassium methacrylate, calcium methacrylate, and/or the like. Examples of the ammonium salt of (meth)acrylic acid may include an ammonia neutralized product, a monoethanolamine neutralized product, a diethanolamine neutralized product, a hydroxylamine neutralized product of (meth)acrylic acid, and/or the like.

The copolymer (A) may further include a unit (a−3) derived from another monomer copolymerizable with the (meth)acrylic acid-based monomer and/or the (meth)acrylonitrile monomer.

The other monomer copolymerizable with the (meth)acrylic acid-based monomer and/or the (meth)acrylonitrile monomer may include, for example, a hydroxyl group-containing monomer, an amide group-containing monomer, or a combination thereof. The hydroxyl group-containing monomer may be, for example, 2-hydroxyethyl(meth)acrylate, 2-hydroxypropyl(meth)acrylate, 4-hydroxybutyl(meth)acrylate, 2-hydroxyhexyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, (4-hydroxymethylcyclohexyl)methyl acrylate, N-methylol (meth)acrylamide, N-hydroxy(meth)acrylamide, vinyl alcohol, allyl alcohol, 2-hydroxyethyl vinyl ether, 4-hydroxy Butyl vinyl ether, diethylene glycol monovinyl ether, and/or the like.

The amide group-containing monomer may be, for example, acrylamide, methacrylamide, diethyl(meth)acrylamide, N-vinylpyrrolidone, N-vinyl-2-pyrrolidone, N-(meth)acryloylpyrrolidone, N,N-dimethylacrylamide, N,N-dimethylmethacrylamide, N,N-diethyl acrylamide, N,N-diethylmethacrylamide, N,N′-methylenebisacrylamide, N,N-dimethylaminopropyl acrylamide, N,N-dimethylaminopropyl methacrylamide, and/or the like.

The unit (a−3) derived from another monomer copolymerizable with the (meth)acrylic acid-based monomer and/or the (meth)acrylonitrile monomer may be greater than about 0 wt % and less than or equal to about 20 wt %, for example, about 1 wt % to about 15 wt %, or about 1 wt % to about 10 wt % based on 100 wt % of the copolymer (A). When the content (e.g., amount) of the unit (a−3) derived from the other monomers copolymerizable with the (meth)acrylic acid-based monomer and/or the (meth)acrylonitrile monomer in the copolymer (A) exceeds about 20 wt %, an effect of suppressing the expansion of the electrode of the negative electrode may be reduced.

The copolymer (A) may be a water-soluble copolymer for dispersion stabilization of the polymer.

A viscosity of the copolymer (A) in an aqueous solution of about 7 wt % of solid content (e.g., amount) may be about 500 mPa·s to about 5000 mPa·s, about 500 mPa·s to about 4000 mPa·s, about 500 mPa·s to about 3000 mPa·s, about 750 mPa·s to about 2500 mPa·s, or about 800 mPa·s to about 2000 mPa·s. When the viscosity is greater than or equal to about 500 mPa·s, a close contacting property of the negative electrode mixture layer to the substrate (e.g., where the negative electrode mixture layer is in close contact with the substrate) may be improved, and when it is less than or equal to about 5000 mPa·s, the active materials are well dispersed to obtain a battery having excellent or suitable cycle characteristics.

The copolymer (B) may include about 35 wt % to about 95 wt % of a unit (b−1) derived from an aromatic vinyl-based monomer and about 5 wt % to about 65 wt % of a unit (b−2) derived from an ethylenically unsaturated monomer based on 100 wt % of the copolymer (B). In this case, flexibility of the binder is improved, cracks do not occur during the application and drying process of the negative electrode slurry, so that the electrode is easy to manufacture, and a close contacting property of the negative electrode mixture layer to the substrate (e.g., where the negative electrode mixture layer is in close contact with the substrate) is improved to obtain a battery with excellent or suitable cycle characteristics.

Examples of the aromatic vinyl-based monomer may include styrene, a-methylstyrene, methoxy styrene, trifluoromethyl styrene, and divinyl benzene.

The ethylenically unsaturated monomer may be at least one of an unsaturated carboxylic acid alkyl ester monomer, a (meth)acrylic acid-based monomer, an unsaturated carboxylic acid amide monomer, and/or a conjugated diene-based monomer.

Examples of the unsaturated carboxylic acid alkyl ester monomer may include 2-ethylhexyl(meth)acrylate, methyl(meth)acrylate, ethyl(meth)acrylate, n-butyl(meth)acrylate, tert-butyl(meth)acrylate, cyclohexyl(meth)acrylate, lauryl(meth)acrylate, benzyl(meth)acrylate, isobornyl(meth)acrylate, 2-hydroxyethyl(meth)acrylate, 2-hydroxypropyl(meth)acrylate, 4-hydroxy butyl(meth)acrylate, glycidyl(meth)acrylate, and/or the like.

Examples of the (meth)acrylic acid-based monomer may include (meth)acrylic acid, maleic acid, fumaric acid, and/or itaconic acid.

Examples of the unsaturated carboxylic acid amide monomer may include (meth)acrylamide, isopropyl acrylamide, N-methylol acrylamide, N-hydroxy ethylacrylamide, N-hydroxy butylacrylamide, dimethyl acrylamide, diethyl acrylamide, and/or the like.

A method for preparing a binder including the copolymer (A) and the copolymer (B) according to one or more embodiments may be a general emulsion polymerization method, an emulsion-free polymerization method (SFEP), a seed polymerization method, a method of polymerization after swelling the seed particles with a monomer, and/or the like.

A method of preparing the binder may be, for example, as follows. A composition containing (meth)acrylic acid monomer and (meth)acrylonitrile monomer, a polymerization initiator, water, and optionally a dispersant, a chain transfer agent, a pH adjuster, etc. is stirred at room temperature in an airtight container equipped with a stirrer and a heating device in an inert gas atmosphere and emulsified in water. As the emulsification method, a method such as stirring, shearing, ultrasonic waves, etc. may be applied, and a stirring blade, a homogenizer, and/or the like may be utilized. Next, the copolymer (A) dispersed in water may be obtained by raising the temperature while stirring to initiate polymerization. The addition method of each monomer during polymerization may be monomer dripping or pre-emulsion dripping other than batch injection, and two or more of these methods may be utilized in combination.

Herein, a method of forming the binder containing the copolymer (A) and the copolymer (B) may be a method of physically mixing the copolymer (A) and a method of forming composite copolymer particles having a structure in which the copolymer (A) is around (e.g., surrounds) the copolymer (B) by utilizing the copolymer (A) as a seed particle. For example, the aromatic vinyl-based monomer and ethylenically unsaturated monomer that is at least one of an unsaturated carboxylic acid alkyl ester monomer, a (meth)acrylic acid-based monomer, an unsaturated carboxylic acid amide monomer, and/or a conjugated diene-based monomer, and a polymerization initiator are added in a system in which the copolymer (A) prepared by the above method is dispersed to grow particles, and the above method may be repeated one or more times, thereby obtaining a binder including copolymer (A) and copolymer (B). As for the preparing apparatus in the case of forming the copolymer (B), the polymerization initiator, water, and a dispersant, a chain transfer agent, a pH adjuster, as needed may utilize those which are the same as the case of preparing the copolymer (A).

In one or more embodiments, in the negative electrode for a rechargeable lithium battery according to one or more embodiments, the active material layer including the silicon-based active material may further include other binders in addition to the binder including the copolymer (A) and the copolymer (B). Here, the other binder may be, for example, a styrene-butadiene rubber, an acrylated styrene-butadiene rubber, an acrylonitrile-butadiene rubber, an acrylic rubber, a butyl rubber, a fluororubber, an ethylene-acrylic acid ester, polyethylene oxide, polyvinylpyrrole, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenolic resin, an epoxy resin, a polyvinyl alcohol, or a combination thereof.

In one or more embodiments, the active material layers including the silicon-based active material may further include a thickener such as carboxymethyl cellulose, polyacrylic acid, and/or polyacrylamide.

### Negative Electrode

The negative electrode for a rechargeable lithium battery according to an embodiment is a type or kind of multi-layer negative electrode including a current collector, a first active material layer on the current collector, and a second active material layer on the first active material layer, and may further include a third active material layer, a fourth active material layer, and/or the like. Such a negative electrode may implement high capacity and high energy density.

The first active material layer and the second active material layer include a silicon-based active material and the aforementioned binder including the copolymer (A) and copolymer (B).

In one or more embodiments, both (e.g., simultaneously) the first active material layer and the second active material layer may each include the same silicon-based active material and the same aforementioned binder (but, e.g., differ in amounts).

In one or more embodiments, the first active material layer and/or the second active material layer including the silicon-based active material may further include a carbon-based active material. For example, in the negative electrode for a rechargeable lithium battery, the first active material layer and the second active material layer may include a silicon-based active material, a carbon-based active material, and a binder.

In one or more embodiments, the silicon content (e.g., amount) in the first active material layer and the second active material layer may be designed to be different from each other. For example, the content (e.g., amount) of silicon included in the first active material layer may be set higher than that of silicon included in the second active material layer. In this case, the content (e.g., amount) of silicon included in the first active material layer may be about 2 to 25 times the content (e.g., amount) of silicon included in the second active material layer. In some embodiments, the content (e.g., amount) of silicon in the first active material layer may be about 10 wt % to about 80 wt %, or about 10 wt % to about 25 wt %, based on 100 wt % of the first active material layer, and the content (e.g., amount) of silicon in the second active material layer may be about 0.1 wt % to about 15 wt % or about 0.1 wt % to about 9 wt % based on 100 wt % of the second active material layer. As another example, the negative electrode may have a concentration gradient in which the content (e.g., amount) of silicon increases from the second active material layer to the first active material layer.

In these one or more suitable forms, the aforementioned binder may effectively suppress or reduce an electrode expansion problem caused by the silicon-based active material.

In the first active material layer, the silicon-based active material may be about 20 wt % to about 99 wt %, or about 30 wt % to about 98 wt %, about 40 wt % to about 98 wt %, about 50 wt % to about 98 wt %, about 60 wt % to about 98 wt %, about 70 wt % to about 98 wt %, about 80 wt % to about 98 wt %, or about 90 wt % to about 98 wt % based on 100 wt % of the first active material layer. In the second active material layer, the silicon-based active material may be about 20 wt % to about 99 wt %, or about 30 wt % to about 98 wt %, about 40 wt % to about 98 wt %, about 50 wt % to about 98 wt %, about 60 wt % to about 98 wt %, about 70 wt % to about 98 wt %, about 80 wt % to about 98 wt %, or about 90 wt % to about 98 wt % based on 100 wt % of the second active material layer.

A content (e.g., amount) of the total active material including the silicon-based active material in the active material layers may be about 90 wt % to about 99 wt % based on 100 wt % of the active material layers.

In one or more embodiments, the aforementioned binder, that is, the binder including the copolymer (A) and the copolymer (B) may be included in the first active material layer in an amount of about 0.1 wt % to about 10 wt %, for example, about 0.1 wt % to about 9 wt %, about 0.1 wt % to about 8 wt %, about 0.1 wt % to about 7 wt %, or about 0.1 wt % to about 6 wt % based on 100 wt % of the first active material layer. In one or more embodiments, the binder including the copolymer (A) and the copolymer (B) may be included in the second active material layer in an amount of about 0.1 wt % to about 10 wt %, for example, about 0.1 wt % to about 9 wt %, about 0.1 wt % to about 8 wt %, about 0.1 wt % to about 7 wt %, or about 0.1 wt % to about 6 wt % based on 100 wt % of the second active material layer. Even in a small amount, the binder may effectively suppress or reduce an electrode expansion phenomenon caused by the silicon-based active material and improve high-temperature cycle-life characteristics of the battery.

In one or more embodiments, a ratio of the binder content in the first active material layer to the binder content in the second active material layer may be 10:90 to 90:10, for example, 20:80 to 80:20, 30:70 to 70:30, 40:60 to 60:40, or 45:55 to 55:45. When the ratio is satisfied, the problem of expansion of the negative electrode due to charge and discharge can be effectively suppressed or reduced, and the cycle-life characteristics of the battery can be improved.

The silicon-based active material may specifically be silicon, silicon-carbon composite, SiOx (0<x≤2), a Si-Q alloy (wherein Q is an element selected from an alkali metal, an alkaline earth metal, a Group 13 element, a Group 14 element, a Group 15 element, a Group 16 element, a transition metal, a rare earth element, and/or a combination thereof, and not Si), or a combination thereof, or a mixture of at least one of them and SiO₂ may be utilized. The element Q may include (e.g., may include one selected from) Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and/or a combination thereof.

The silicon-based active material may include, for example, a silicon-carbon composite including silicon particles and a first carbon-based material. Herein, the first carbon-based material may be crystalline carbon, amorphous carbon, or a combination thereof. When such a silicon-carbon composite is utilized as a silicon-based active material, stable cycle characteristics may be realized while exhibiting a high capacity.

In the silicon-carbon composite including the silicon particles and the first carbon-based material, a content (e.g., amount) of the silicon particles may be about 30 wt % to about 70 wt %, for example, about 40 wt % to about 50 wt %. A content (e.g., amount) of the first carbon-based material may be about 70 wt % to about 30 wt %, for example, about 50 wt % to about 60 wt %. When the silicon particles and the content (e.g., amount) of the first carbon-based material are included in the above ranges, high capacity characteristics and excellent or suitable cycle-life characteristics may be exhibited at the same time.

In one or more embodiments, the silicon-based active material may include (1) a silicon-carbon composite including a core in which silicon particles and a second carbon-based material are mixed and (2) a third carbon-based material is around (e.g., surrounding) the core. Such a silicon-carbon composite may realize a very high capacity and at the same time improve a capacity retention rate and high-temperature cycle-life characteristics of the battery.

Herein, the third carbon-based material may have a thickness of about 5 nm to about 100 nm. In one or more embodiments, based on 100 wt % of the silicon-carbon composite, the third carbon-based material may be included in an amount of about 1 wt % to about 50 wt %, the silicon particle may be included in an amount of about 30 wt % to about 70 wt %, and the second carbon-based material may be included in an amount of about 20 wt % to about 69 wt %. When the contents of the silicon particles, the third carbon-based material, and the second carbon-based material are included in the above ranges, discharge capacity is excellent or suitable and a capacity retention rate may be improved.

A particle diameter of the silicon particles may be about 10 nm to about 30 μm, for example, about 10 nm to about 1000 nm, or about 20 nm to about 150 nm. When the average particle diameter of the silicon particles is included in the above range, a volume expansion occurring during charging and discharging may be suppressed or reduced, and interruption of electron movement due to particle crushing during charging and discharging may be prevented or reduced.

In the silicon-carbon composite, for example, the second carbon-based material may be crystalline carbon and the third carbon-based material may be amorphous carbon. For example, the silicon-carbon composite may be a silicon-carbon composite including a core including silicon particles and crystalline carbon and an amorphous carbon coating layer disposed on the surface of the core.

The crystalline carbon may include artificial graphite, natural graphite, or a combination thereof. The amorphous carbon may include pitch carbon, soft carbon, hard carbon, mesophase pitch carbonized product, calcined coke, a carbon fiber, and/or a combination thereof. The precursor of the amorphous carbon may be a coal-based pitch, mesophase pitch, petroleum-based pitch, coal-based oil, petroleum-based heavy oil, and/or a polymer resin such as a phenol resin, a furan resin, and/or a polyimide resin.

The silicon-carbon composite may include about 10 wt % to about 60 wt % of the silicon and about 40 wt % to about 90 wt % of the carbon-based material based on 100 wt % of the silicon-carbon composite. In one or more embodiments, in the silicon-carbon composite, a content (e.g., amount) of the crystalline carbon may be about 10 wt % to about 70 wt % and a content (e.g., amount) of the amorphous carbon may be about 20 wt % to about 40 wt % based on the total weight of the silicon-carbon composite.

The silicon particles may exist in an oxidized form, and in this case, an atomic content (e.g., atomic amount) ratio of Si:O in the silicon particles indicating a degree of oxidation may be about 99:1 to about 33:67. The silicon particles may be SiOx particles, and in this case, the range of x in SiOx may be greater than about 0 and less than about 2. As utilized herein, when a definition is not otherwise provided, an average particle diameter (D50) indicates a diameter of particles having a cumulative volume of 50% by volume in the particle size distribution.

In one or more embodiments, any one or more of the negative active material layers including the silicon-based active material may further include a carbon-based active material in addition to the silicon-based active material. When the silicon-based active material and the carbon-based active material are mixed and utilized, a mixing ratio may be about 1:99 to about 90:10, for example, about 1:99 to about 40:60, about 30:70 to about 70:30, or about 50:50 to about 90:10 by weight.

The carbon-based active material may be a carbon-containing active material generally utilized for a negative electrode, and may include crystalline carbon, amorphous carbon, or a combination thereof. Examples of the crystalline carbon may include graphite such as amorphous, plate-like, flake, spherical or fibrous natural graphite or artificial graphite, and examples of the amorphous carbon may include soft carbon, hard carbon, a mesophase pitch carbonized product, and calcined coke.

In one or more embodiments, the first active material layer and/or the second active material layer may include a general negative electrode binder in addition to the binder. The general negative electrode binder may be included in the first active material layer and/or the second active material layer in an amount of about 0.1 wt % to about 5 wt % based on the total weight (100 wt %) of the respective active material layer (e.g., based on 100 wt % of the first active material layer and/or 100 wt % of the second active material layer, respectively). In one or more embodiments, the general negative electrode binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may include (e.g., may be selected from) a styrene-butadiene rubber, an acrylated styrene-butadiene rubber, an acrylonitrile-butadiene rubber, an acrylic rubber, a butyl rubber, a fluororubber, and/or a combination thereof. The polymer resin binder may include (e.g., may be selected from) polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and/or a combination thereof.

When a water-soluble binder is utilized as the negative electrode binder, a cellulose-based compound capable of imparting viscosity may be further included. As the cellulose-based compound, a mixture of one or more of carboxymethyl cellulose, hydroxypropylmethyl cellulose, methyl cellulose, or alkali metal salts thereof may be utilized. As the alkali metal, Na, K or Li may be utilized. The amount of the thickener utilized may be about 0.1 parts by weight to about 3 parts by weight based on 100 parts by weight of the negative active material.

At least one of the first active material layer and the second active material layer may further include a conductive material. The conductive material is included to provide electrode conductivity and any electrically conductive material may be utilized as a conductive material unless it causes a chemical change in a battery. Examples of the conductive material include a carbon-based material such as natural graphite, artificial graphite, carbon black, acetylene black, ketjen black, a carbon fiber, carbon nanotube, and/or the like; a metal-based material of a metal powder or a metal fiber including copper, nickel, aluminum silver, and/or the like; a conductive polymer such as a polyphenylene derivative; or a mixture thereof. The conductive material may be included in an amount of about 0.1 wt % to about 5 wt %, or about 1 wt % to about 4 wt % based on 100 wt % of the active material layer including the conductive material.

The current collector may include (e.g., may include one selected from) a copper foil, a nickel foil, a stainless steel foil, a titanium foil, a nickel foam, a copper foam, a polymer substrate coated with a conductive metal, and/or a combination thereof.

### Positive Electrode

A positive electrode for a rechargeable lithium battery includes a current collector and a positive active material layer on the current collector. The positive electrode may include a positive active material, and may further include a binder and/or a conductive material.

The positive active material may include lithiated intercalation compounds that reversibly intercalate and deintercalate lithium ions. Examples of the positive active material include a compound represented by any one of the following chemical formulas:LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}CO_{b}X_{c}Dₐ (0.90≤a≤1.8, 0≤b≤0.5, 0≤c≤0.5, 0≤a≤2); LiₐNi_{1-b-c}Co_{b}X_{c}O_{2-α}T_{α}(0.90≤a≤1.8, 0≤b≤0.5, 0≤c≤0.05, 0≤α≤2); LiₐNi_{1-b-c}Co_{b}X_{c}O_{2-α}T₂ (0.90≤a≤1.8, 0≤b≤0.5, 0≤c≤0.05, 0≤α≤2); LiₐNi_{1-b-c}Mn_{b}X_{c}Dₐ (0.90≤a≤1.8, 0≤b≤0.5, 0≤c≤0.05, 0≤a≤2); LiₐNi_{1-b-c}Mn_{b}X_{c}O_{2-α}T_{α} (0.90≤a≤1.8, 0≤b≤0.5, 0≤c≤0.05, 0≤α≤2); LiₐNi_{1-b-c}Mn_{b}X_{c}O_{2-α}T₂ (0.90≤a≤1.8, 0≤b≤0.5, 0≤c≤0.05, 0≤α≤2); LiₐNi_{b}E_{c}G_{d}O₂(0.90≤a≤1.8, 0≤b≤0.9, 0≤c≤0.5, 0.001≤d≤0.1); LiₐNi_{b}CO_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); and/or LiₐFePO₄ (0.90≤a≤1.8).

In chemical formulas, A includes (e.g., is selected from) Ni, Co, Mn, and/or a combination thereof; X includes (e.g., is selected from) Al, Ni, Co, Mn, Cr, Fe, Mg, Sr, V, a rare earth element, and/or a combination thereof; D includes (e.g., is selected from) O, F, S, P, and/or a combination thereof; E includes (e.g., is selected from) Co, Mn, and/or a combination thereof; T includes (e.g., is selected from) F, S, P, and/or a combination thereof; G includes (e.g., is selected from) Al, Cr, Mn, Fe, Mg, La, Ce, Sr, V, and/or a combination thereof; Q includes (e.g., is selected from) Ti, Mo, Mn, and/or a combination thereof; Z includes (e.g., is selected from) Cr, V, Fe, Sc, Y, and/or a combination thereof; and J includes (e.g., is selected from) V, Cr, Mn, Co, Ni, Cu, and/or a combination thereof.

The compound may have a coating layer on the surface, or may be mixed with another compound having a coating layer. The coating layer may include at least one coating element compound including (e.g., selected from) an oxide of a coating element, a hydroxide of a coating element, an oxyhydroxide of a coating element, an oxycarbonate of a coating element, and/or a hydroxy carbonate of a coating element. The compound of the coating layer may be amorphous or crystalline. The coating element included in the coating layer may include Mg, Al, Co, K, Na, Ca, Si, Ti, V, Sn, Ge, Ga, B, As, Zr, or a combination thereof. The coating layer forming process may utilize a method that does not adversely affect the physical properties of the positive active material, for example, spray coating, dipping, and/or the like.

The positive active material may be, for example, at least one type or kind of lithium composite oxide represented by Chemical Formula 11.

LiₐM¹¹_{1-y11-z11}M¹²_{y11}M¹³_{z11}O₂ Chemical Formula 11

In Chemical Formula 11, 0.9≤a≤1.8, 0≤y11≤1, 0≤z11≤1, 0≤y11+z11<1, and M¹¹, M¹², and M¹³ may each independently be at least one element of (e.g., one selected from) Ni, Co, Mn, Al, Mg, Ti, Fe, and/or a combination thereof.

For example, M¹¹ may be Ni and M¹² and M¹³ may each independently be a metal of Co, Mn, Al, Mg, Ti, or Fe. As a specific example, M¹¹ may be Ni, M¹² may be Co, and M¹³ may be Mn or Al, but the present disclosure is not limited thereto.

In one or more embodiments, the positive active material may be a lithium composite oxide represented by Chemical Formula 12.

Liₓ₁₂Ni_{y12}CO_{z12}M¹⁴_{1-y12-z12}O₂ Chemical Formula 12

In Chemical Formula 12, 0.9≤x12≤1.2, 0.5≤y12≤1, and 0<z12≤0.5, and M¹⁴ includes (e.g., is selected from) Al, B, Ce, Cr, F, Mg, Mn, Mo, Nb, P, S, Si, Sr, Ti, V, W, Zr, and/or a combination thereof.

A content (e.g., amount) of the positive active material may be about 90 wt % to about 98 wt %, for example about 90 wt % to about 95 wt % based on the total weight of the positive active material layer. The content (e.g., amount) of each of the binder and the conductive material may be about 1 wt % to about 5 wt % based on the total weight of the positive active material layer.

The binder improves binding properties of positive active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but are not limited thereto.

The conductive material is utilized to impart conductivity to the electrode, and any material may be utilized as long as it does not cause chemical changes in the battery to be configured and is an electron conductive material. Examples of the conductive material may include a carbon-based material such as natural graphite, artificial graphite, carbon black, acetylene black, ketjen black, carbon fiber, carbon nanotube, and/or the like; a metal-based material of a metal powder or a metal fiber, and/or the like including copper, nickel, aluminum silver, and/or the like; a conductive polymer such as a polyphenylene derivative; or a mixture thereof.

The current collector may include an aluminum foil, but is not limited thereto.

### Rechargeable Lithium Battery

One or more embodiments of the present disclosure provide a rechargeable lithium battery including a positive electrode, a negative electrode, a separator between the positive electrode and the positive electrode, and an electrolyte.

The drawing is a schematic view illustrating a rechargeable lithium battery according to one or more embodiments of the present disclosure. Referring to the drawing, a rechargeable lithium battery 100 according to one or more embodiments includes a battery cell including a positive electrode 114, a negative electrode 112 facing the positive electrode 114, a separator 113 between the positive electrode 114 and the negative electrode 112, and an electrolyte for a rechargeable lithium battery impregnating the positive electrode 114, the negative electrode 112, and the separator 113, a battery case 120 housing the battery cell, and a sealing member 140 sealing the battery case 120.

The electrolyte includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, and/or alcohol-based solvent, and/or aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. Examples of the ester-based solvent include methyl acetate, ethyl acetate, n-propyl acetate, dimethyl acetate, methyl propionate, ethyl propionate, y-butyrolactone, decanolide, valerolactone, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like and the ketone-based solvent may be cyclohexanone, and/or the like.

In one or more embodiments, the alcohol-based solvent may be ethyl alcohol, isopropyl alcohol, etc. and the aprotic solvent may be nitriles such as R-CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and/or the like.

The non-aqueous organic solvent may be utilized alone or in a mixture. When the organic solvent is utilized in a mixture, the mixture ratio may be controlled or selected in accordance with a desirable battery performance.

In one or more embodiments, in the case of the carbonate-based solvent, a mixture of a cyclic carbonate and a chain carbonate may be utilized. In this case, when the cyclic carbonate and the chain carbonate are mixed in a volume ratio of about 1:1 to about 1:9, the electrolyte may exhibit excellent or suitable performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be utilized.

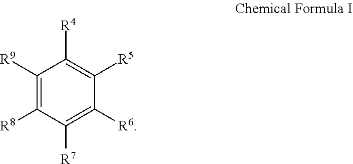

In Chemical Formula I, R⁴ to R⁹ may each independently be the same or different and may include (e.g., are selected from) hydrogen, a halogen, a C1 to C10 alkyl group, a haloalkyl group, and/or a combination thereof.

Specific examples of the aromatic hydrocarbon-based solvent may be (e.g., may be selected from)benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include vinylene carbonate or an ethylene carbonate-based compound of Chemical Formula II in order to improve cycle-life of a battery.

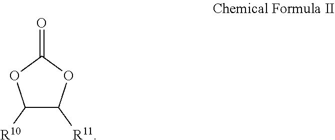

In Chemical Formula II, R¹⁰ and R¹¹ may each independently be the same or different, and may include (e.g., are selected from) hydrogen, a halogen, a cyano group, a nitro group, and/or fluorinated C₁ to C₅ alkyl group, provided that at least one of R¹⁰ and R¹¹ includes (e.g., is selected from) a halogen, a cyano group, a nitro group, and/or fluorinated C₁ to C₅ alkyl group, but both of R¹⁰ and R¹¹ are not hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be utilized within an appropriate or suitable range.

The lithium salt dissolved in the non-aqueous organic solvent supplies lithium ions in a battery, enables a basic operation of a rechargeable lithium battery, and improves transportation of the lithium ions between positive and negative electrodes.

Examples of the lithium salt include at least one supporting salt of (e.g., one selected from) LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide):LiFSI), LiC₄F₉SO₃, LiClO₄, LiAlO₂, LiAICl₄, LiPO₂F₂, LiN(CₓF₂ₓ₊₁SO₂)(C_{y}F_{2y+1}SO₂), wherein x and y are natural numbers, for example, an integer in a range of 1 to 20, lithium difluoro(bisoxolato)phosphate, LiCl, Lil, LiB(C₂O₄)₂ (lithium bis(oxalato) borate, LiBOB), and/or lithium difluoro(oxalato)borate (LiDFOB).

The lithium salt may be utilized in a concentration in a range of about 0.1 M to about 2.0 M. When the lithium salt is included at the above concentration range, an electrolyte may have excellent or suitable performance and lithium ion mobility due to optimal or suitable electrolyte conductivity and viscosity.

The separator 113 separates a positive electrode 114 and a negative electrode 112 and provides a transporting passage for lithium ions and may be any generally-utilized separator in a lithium ion battery. In other words, it may have low resistance to ion transport and excellent or suitable impregnation for an electrolyte. For example, the separator may include (e.g., may be selected from) a glass fiber, polyester, polyethylene, polypropylene, polytetrafluoroethylene, and/or a combination thereof and may have a form of a non-woven fabric or a woven fabric. For example, in a lithium ion battery, a polyolefin-based polymer separator such as polyethylene and polypropylene is mainly utilized. In order to ensure the heat resistance or mechanical strength, a coated separator including a ceramic component or a polymer material may be utilized. Optionally, it may have a mono-layered or multi-layered structure.

Rechargeable lithium batteries may be classified as lithium ion batteries, lithium ion polymer batteries, and lithium polymer batteries according to the presence of a separator and the type or kind of electrolyte utilized therein. The rechargeable lithium batteries may have a variety of shapes and sizes, and include cylindrical, prismatic, coin, or pouch-type or kind batteries, and may be thin film batteries or may be rather bulky in size. Structures and manufacturing methods for these batteries pertaining to this disclosure are well known in the art.

Hereinafter, examples of the present disclosure and comparative examples are described. It is to be understood, however, that the examples are for the purpose of illustration and are not to be construed as limiting the present disclosure.

### Example 1

### (1) Preparation of Binder

In a 0.5 L four-necked flask equipped with a stirrer, a thermometer, a cooling tube, and a liquid feeding pump, 270 g of water is put (e.g., added), and an internal pressure thereof is reduced to 20 mmHg with an aspirator and returned to normal pressure with nitrogen. Subsequently, the flask is maintained under the nitrogen atmosphere, and the water is heated to 60° C. in an oil bath, while stirring. Then, 0.12 g of ammonium persulfate is dissolved in 5 g of water to prepare an ammonium persulfate aqueous solution, and the ammonium persulfate aqueous solution is added to the flask.

The ammonium persulfate aqueous solution is added to the water in the flask, and a mixture of 19.4 g of acrylic acid (Wako Pure Chemical Industries, Ltd.) and 9.0 g of acrylonitrile (Wako Pure Chemical Industries, Ltd.) is added dropwise thereto. The aqueous solution in the flask is continuously stirred for 4 hours and then, heated to 80° C. In addition, the aqueous solution is continuously stirred for 2 hours. The aqueous solution is cooled to room temperature, and 15 g of aqueous ammonia is added thereto and then, stirred.

The aqueous solution in the flask is cooled to room temperature, and about 1 mL of the aqueous solution is put in an aluminum pan and dried on a hot plate heated to 160° C. for 15 minutes. Subsequently, the residue is measured with respect to mass, which is utilized to calculate mass % (i.e., mass % of non-volatile matter) of the residue. The process completes a synthesis of an acrylic acid ammonium/acrylonitrile copolymer corresponding to a copolymer (A).

The copolymer (A) is mixed with styrene-butadiene rubber corresponding to a copolymer (B) in a weight ratio of 40:60, preparing a final binder.

### (2) Manufacture of Negative Electrode

14.55 wt % of a silicon-based active material, 82.45 wt % of an artificial graphite active material, and 3 wt % of the binder are dispersed, preparing first negative active material slurry. The first negative active material slurry is coated on a copper current collector and then, dried, forming a first active material layer. Herein, the silicon-based active material uses a silicon-carbon composite having a core including artificial graphite and silicon particles and a soft carbon coated on the surface of the core. The silicon particles have an average particle diameter (D50) of about 100 nm, and the soft carbon coating layer has a thickness of about 20 nm.

The same as the first negative electrode active material slurry is prepared as a second negative electrode active material slurry. This is coated on the first active material layer and dried to prepare a second active material layer.

The current collector, the first active material layer, and the second active material layer stacked in this order are compressed by a roll press to manufacture a negative electrode.

### (3) Manufacture of Positive Electrode

97.7 wt % of Li_{1.0}Ni_{0.88}Co_{0.1}Al_{0.01}Mg_{0.01}O₂, 1.0 wt % of acetylene black, and 1.3 wt % of polyvinylidene fluoride are dispersed and mixed in an N-methyl-2-pyrrolidone solvent to prepare a cathode active material slurry. This is coated on the cross-section of an aluminum current collector, dried, and then compressed with a roll press to manufacture a positive electrode.

### (4) Manufacture of Rechargeable Lithium Battery Cell

An electrode stack structure is obtained by disposing a polyethylene porous separator between the negative and positive electrodes and housed in a case, and after injecting an electrolyte solution thereinto, the case is sealed under a reduced pressure, manufacturing a rechargeable lithium battery cell. The electrolyte solution is prepared by dissolving 1 M of LiPF₆ and 1 wt % of vinylene carbonate in a mixed solvent of ethylene carbonate and dimethyl carbonate in a volume ratio of 3:7.

### Comparative Example 1

A mixture of 97 wt % of artificial graphite, 1 wt % of carboxymethyl cellulose, and 2 wt % of styrene-butadiene rubber in a water solvent is used as both a first active material slurry and a second active material slurry. Except for this, a negative electrode, a positive electrode, and a rechargeable lithium battery cell are manufactured in substantially the same manner as in Example 1.

### Comparative Example 2

A first active material is prepared by mixing 97 wt % of artificial graphite, 1 wt % of carboxymethyl cellulose, and 2 wt % of styrene-butadiene rubber in a water solvent. A second active material is prepared by mixing 14.55 wt % of the same silicon-based active material as in Example 1, 82.45 wt % of artificial graphite, and 3 wt % of the binder prepared in Example 1. Except for this, a negative electrode, a positive electrode, and a rechargeable lithium battery cell are manufactured in substantially the same manner as in Example 1.

### Comparative Example 3

A first active material is prepared by mixing 14.55 wt % of the same silicon-based active material as in Example 1, 84.65 wt % of artificial graphite, and 0.8 wt % of the binder prepared in Example 1. A second active material is prepared by mixing 97 wt % of artificial graphite, 1 wt % of carboxymethyl cellulose, and 2 wt % of styrene-butadiene rubber in a water solvent. Except for this, a negative electrode, a positive electrode, and a rechargeable lithium battery cell are manufactured in substantially the same manner as in Example 1.

### Evaluation Example 1: Evaluation of Cell Thickness Changes during Cycling

The rechargeable lithium battery cells according to Example 1 and Comparative Examples 1 to 3 are constant current-charged to 4.2 V at a 0.2 C rate and subsequently cut off at a 0.025 C rate in the constant voltage mode at 25° C. and then, measured with respect to initial cell thickness changes, and the results are shown in Table 1.

### Evaluation Example 2: Evaluation of Room Temperature Cycle-life Characteristics of Battery Cells

The rechargeable lithium battery cells of Example 1 and Comparative Examples 1 to 3 are constant current-charged to a voltage of 4.2 V at a 0.5 C rate and subsequently, cut off in the constant voltage mode at a 0.025 C rate at 25° C. Subsequently, the cells are discharged to 2.5 V at a 0.5 C rate, and this charge and discharge process is about 50 times repeated and then, evaluated with respect to capacity retention according to the cycle numbers, and the results are shown in Table 1.

TABLE 1

| | | | Comparative | Comparative | Comparative |
|---|---|---|---|---|---|
| | | Example 1 | Example 1 | Example 2 | Example 3 |
| | Second | Prepared | CMC + SBR | Prepared | CMC + SBR |
| | layer | binder 3% | 3% | binder 3% | 3% |
| Binder | First | Prepared | CMC + SBR | CMC + SBR | Prepared |
| composition | layer | binder 3% | 3% | 3% | binder 0.8% |
| Initial thickness | | 12.1 | 21.6 | 16.7 | 16.2 |
| expansion rate (%) | | | | | |
| Capacity retention | | 94.1 | 70.3 | 85.7 | 80.3 |
| (@50 cycle, %) | | | | | |

Referring to Table 1, Example 1 exhibits a reduced cell thickness expansion rate compared to Comparative Examples 1 to 3. Accordingly, the binder according to one or more embodiments is applied to the first and second negative active material layer, effectively controlling the battery expansion problem by the silicon-based active material during the cycles.

Furthermore, referring to the capacity retention of Table 1, Example 1 exhibits significantly higher capacity retention rate at the 50th cycle than Comparative Examples 1 to 3. Accordingly, the binder of one or more embodiments of the present disclosure is applied to the first and second negative active material layer, improving high temperature cycle-life characteristics.

In the present disclosure, when particles are spherical, “diameter” indicates a particle diameter or an average particle diameter, and when the particles are non-spherical, the “diameter” indicates a major axis length or an average major axis length. The diameter (or size) of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

As used herein, the term “and/or” includes any and all combinations of one or more of the associated listed items. Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

The portable device or vehicle, and/or the battery, e.g., a battery controller, and/or any other relevant devices or components according to embodiments of the present invention described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

While this disclosure has been described in connection with what is presently considered to be practical example embodiments, it is to be understood that the present disclosure is not limited to the disclosed embodiments. In contrast, it is intended to cover one or more suitable changes and modifications and equivalent arrangements included within the spirit and scope of the appended claims and equivalents thereof.

Reference Numerals

| | |
|---|---|
| 100: | rechargeable lithium battery |
| 112: | negative electrode |
| 113: | separator |
| 114: | positive electrode |
| 120: | battery case |
| 140: | sealing member |

What is claimed is:

1. A negative electrode for a rechargeable lithium battery, the negative electrode comprising a current collector;
a first active material layer on the current collector; and
a second active material layer on the first active material layer,
wherein the first active material layer and the second active material layer each independently comprises a silicon-based active material and a binder, and
the binder comprises a copolymer (A) and a copolymer (B), and
wherein the copolymer (A) comprises a unit (a−1) derived from a (meth)acrylic acid-based monomer and a unit (a−2) derived from a (meth)acrylonitrile monomer, and
the copolymer (B) comprises a unit (b−1) derived from an aromatic vinyl-based monomer and a unit (b−2) derived from an ethylenically unsaturated monomer that is at least one of an unsaturated carboxylic acid alkyl ester monomer, a (meth)acrylic acid-based monomer, an unsaturated carboxylic acid amide monomer, or a conjugated diene monomer.

2. The negative electrode of claim 1, wherein
the copolymer (A) and the copolymer (B) are physically mixed with each other in the binder.

3. The negative electrode of claim 1, wherein
at least a portion of the copolymer (B) is around the copolymer (A) in the binder.

4. The negative electrode of claim 1, wherein
in the binder, a weight ratio of copolymer (A) and copolymer (B) (A:B) is about 30:70 to about 70:30.

5. The negative electrode of claim 1, wherein
the copolymer (A) comprises about 30 wt % to about 70 wt % of the unit (a−1) derived from the (meth)acrylic acid-based monomer and about 30 wt % to about 70 wt % of the unit (a−2) derived from (meth)acrylonitrile based on 100 wt % of the copolymer (A).

6. The negative electrode of claim 1, wherein
the copolymer (A) further comprises a unit (a−3) derived from another monomer copolymerizable with the (meth)acrylic acid-based monomer and/or the (meth)acrylonitrile monomer, and
the other monomer copolymerizable with the (meth)acrylic acid-based monomer and/or the (meth)acrylonitrile monomer comprises a hydroxyl group-containing monomer, an amide group-containing monomer, or a combination thereof.

7. The negative electrode of claim 6, wherein
the unit (a−3) derived from the other monomer copolymerizable with the (meth)acrylic acid-based monomer and/or the (meth)acrylonitrile monomer is greater than about 0 wt % and less than or equal to about 20 wt % based on 100 wt % of the copolymer.

8. The negative electrode of claim 1, wherein
a viscosity of the copolymer (A) in an aqueous solution of about 7 wt % of solid content is about 500 mPa·s to about 5000 mPa·s.

9. The negative electrode of claim 1, wherein
the unit (b−2) derived from the ethylenically unsaturated monomer is in an amount of greater than or equal to about 5 wt % based on 100 wt % of the copolymer (B).

10. The negative electrode of claim 1, wherein
the first active material layer comprises about 0.1 wt % to about 8 wt % of the binder based on 100 wt % of the first active material layer.

11. The negative electrode of claim 1, wherein
the second active material layer comprises about 0.1 wt % to about 8 wt % of the binder based on 100 wt % of the second active material layer.

12. The negative electrode of claim 1, wherein
a ratio of the binder content in the first layer to the binder content in the second layer is 10:90 to 90:10.

13. The negative electrode of claim 1, wherein
the first active material layer and/or the second active material layer further comprises a carbon-based active material.

14. The negative electrode of claim 1, wherein
content of silicon in the first active material layer is about 2 to 25 times that of silicon in the second active material layer.

15. The negative electrode of claim 1, wherein
the negative electrode has a concentration gradient in which content of silicon increases from the second active material layer to the first active material layer.

16. The negative electrode of claim 1, wherein
the silicon-based active material comprises a silicon-carbon composite comprising silicon particles and a first carbon-based material.

17. The negative electrode of claim 14, wherein
the first carbon-based material comprises artificial graphite, natural graphite, or a combination thereof.

18. The negative electrode of claim 1, wherein
the silicon-based active material comprises a silicon-carbon composite comprising:
a core in which silicon particles and a second carbon-based material are mixed; and
a third carbon-based material is around the core.

19. The negative electrode of claim 16, wherein
the second carbon-based material is crystalline carbon comprising artificial graphite, natural graphite, or a combination thereof, and
the third carbon-based material is amorphous carbon comprising pitch carbon, soft carbon, hard carbon, a mesophase pitch carbonized product, calcined coke, a carbon fiber, or a combination thereof.

20. A rechargeable lithium battery comprising
the negative electrode for the rechargeable lithium battery of claim 1,
a positive electrode, and
an electrolyte.
